(19) United States
(12) Patent Application Publication
(10) Pub. No.: US 2008/0044030 A1
(43) Pub. Date: Feb. 21, 2008

(54) PROTECTED CONTACT DATA IN AN ELECTRONIC DIRECTORY

(75) Inventor: Abhishek Kumar Mishra, Hyderabad (IN)

Correspondence Address: SENNIGER POWERS (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/462,421

(22) Filed: Aug. 4, 2006

(51) Int. Cl. H04L 9/00

(52) U.S. Cl. 380/279

(57) ABSTRACT

A sever application allows an administrator of a server to selectively designate contact data of a particular individual to be encrypted prior to storage in a shared electronic directory. The server application encrypts any designated content and stores the encrypted content in the shared electronic directory. The server application is responsive to a valid directory request received from a user of a telecommunication device to transfer encrypted content and non-encrypted content to the telecommunication device. The server application also transfers a decryption key and a key expiration parameter from the server to the telecommunication device. A client application executing on the telecommunication device can use the decryption key within a time period defined by the key expiration parameter to decrypt encrypted contacted data on the telecommunication device to initiate contact with the particular individual.

### BACKGROUND

With the growth of computer and information systems and related network technologies such as wireless and Internet communications, ever increasing amounts of electronic information are communicated, transferred and subsequently processed by users and/or systems. As an example, wireless telecommunication devices such as mobile phones are not only a popular method for voice communications, but are also a popular means for communicating various types of electronic information. In particular, with the advent of wireless Internet technology, such telecommunication devices are being used by more and more people to retrieve and store contact information for the purpose of initiating contact with one or more individuals. For example, conventional telecommunication devices provide users the ability to access an electronic directory that serves as a centralized place where users can keep all their contact information. More specifically, users can view custom electronic directories that store email addresses, names, telephone numbers, and other contact information for individuals they frequently communicate with via the telecommunication device.

Organizations and businesses frequently maintain custom electronic directories that store information for employees, contractors, and/or clients and may provide the same employees, contractors, and/or clients that have been authorized the ability to download contact information from the electronic directory for storage in a local directory on their telecommunication device. However, for business and/or security reasons, it may be prudent to keep some of an individual's contact information private and/or limit the duration downloaded contact information can be used to initiate contact with a particular individual. For example, consider a client meets with a financial advisor John of company XYZ. The client gives John his phone number which John stores in his mobile phone. After John leaves company XYZ and joins company ABC, he still has the client's number stored in his mobile phone and calls the client asking him to bring his investments to Bank ABC. This is could potentially result in company XYZ losing a client. As another example, consider a company has contracted with a particular taxi service to provide employees safe transportation to their vehicle or home when leaving work during a particular period of time (e.g., 8 PM-6 AM). The company provides the taxi drivers phone number of all the employees to be picked up and the drivers give a call 5-10 minutes before the person is to be picked up. If a particular taxi driver's employment is later terminated, the driver will still have the employees numbers stored in his mobile phone and can call a particular employee under the pretext that he is still a driver, when in fact, the ex-driver may have more deviant motives.

Thus, even if a particular individual agrees to have their name and telephone number information included in the custom directory, that individual or the Organization may desire to keep their phone number private. Unfortunately, after contact information is downloaded from a shared electronic directory, conventional telecommunication devices allow users to view all of the downloaded contact information. As a result, some individual may request that there information not be maintained in such a shared electronic directory.

### SUMMARY

Aspects of the invention allow for the storage of non-encrypted and encrypted contact data in a custom address directory. One embodiment of the invention provides a server application for defining and selectively designating contact data for encryption prior to storage in the custom directory, and for defining an expiration time after which the contact data is unusable after being downloaded to an end user of a telecommunication device. Other embodiments of the invention involve a client application for decrypting encrypted contact data downloaded from a custom directory required to initiate contact with a particular individual, while preventing the decrypted contact data from being viewed by the user of the telecommunication device. Accordingly, a user of the telecommunication can initiate contact with a particular individual, but cannot view the decrypted contact data required to initiate contact.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a suitable operating environment in which embodiments of the invention may be implemented.

FIG. 2A is an exemplary block diagram illustrating components of a server email application according to one embodiment of the invention.

FIG. 2B is a screen shot of an exemplary directory form defining contact data according to one embodiment of the invention.

FIG. 3A is an exemplary block diagram illustrating components of a client application according to one embodiment of the invention.

FIG. 3B is an exemplary telecommunication for interacting with a server according to one embodiment of the invention.

FIG. 4 is an exemplary flow chart illustrating a method for storing contact data to be stored in a shared electronic directory according to one exemplary embodiment of the invention.

FIG. 5 is an exemplary flow chart illustrating a method for transferring contact data from a server to a telecommunication device according to one exemplary embodiment of the invention,

FIG. 6 is an exemplary flow chart illustrating a method for initiating contact via a telecommunication device using encrypted contact data received from a server according to one exemplary embodiment of the invention.

Corresponding reference characters indicate corresponding parts throughout the drawings.

### DETAILED DESCRIPTION

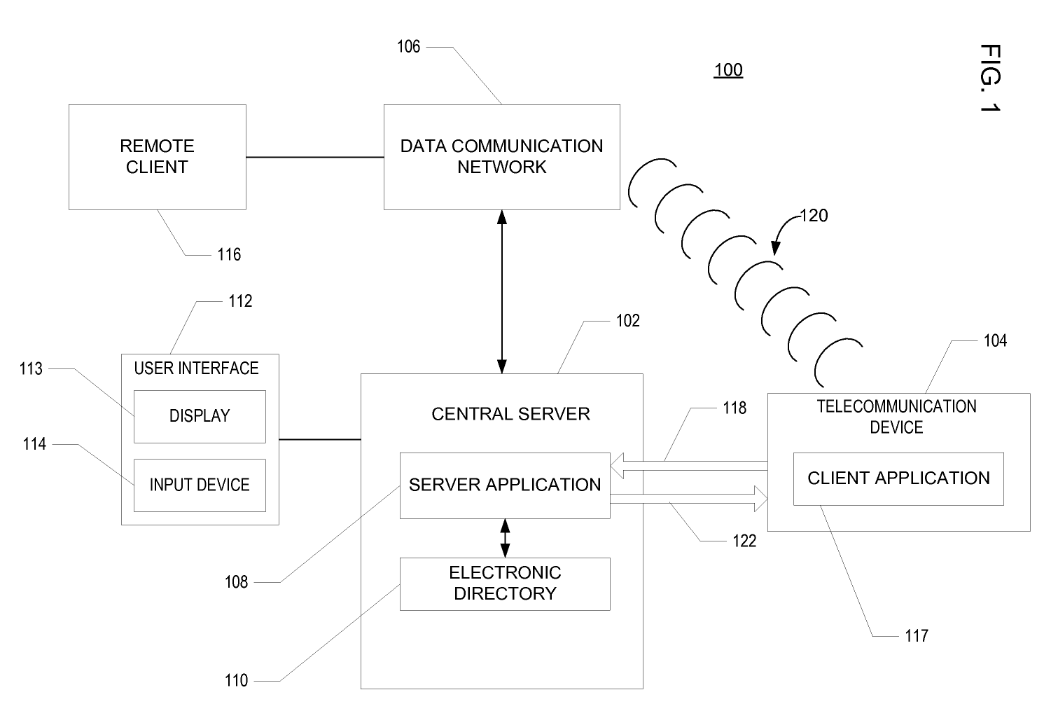

Referring first to FIG. 1, an exemplary block diagram illustrates a suitable operating environment 100 in which embodiments of the invention may be implemented. In this instance, FIG. 1 diagrammatically shows cross network communication between a central server 102 and a telecommunication device 104. More specifically, embodiments of the invention are described in the context of the server 102 communicatively linked to the telecommunication device 104 such that contact data stored in an electronic directory can be exchanged between the server 102 and the telecommunication device 104. The central server 102 is coupled to the telecommunication device 104 via a data communication network 106. In this example, the data communication network 106 is the Internet (or the World Wide Web) and facilitates the transfer of contact data between the server 102 and the telecommunication device 104. However, the teachings of the invention can be applied to any data communication network. In this example, the server 102 and telecommunication device 104 communicate data among themselves using the a Wireless Application Protocol (WAP), a protocol commonly used to provide Internet service to digital mobile phones and other wireless terminals.

The server 102 executes a server application 108 to create and/or update an electronic directory 110 storing contact data for one or more individuals. The electronic directory 110 stores contact data such as the first name, last name, email address, phone number, mailing address, job title, and employer name of one or more individuals that have agreed to have their contact information included in the electronic directory 110.

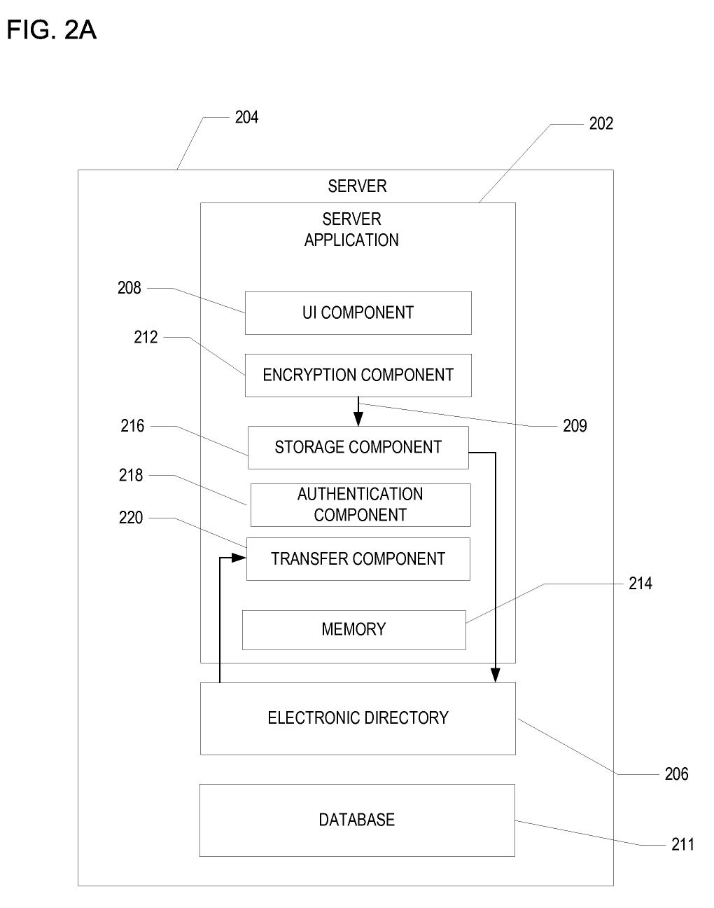

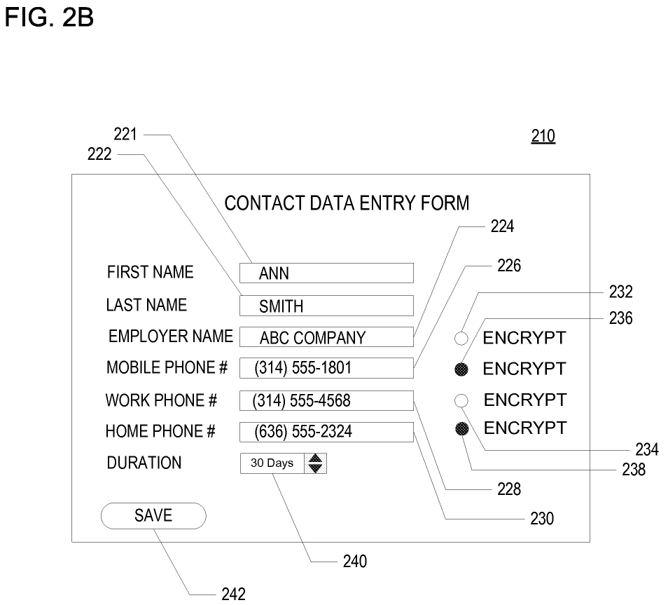

A user-interface (UI) 112 coupled to the server 102 allows an administrator, or user, of the server 102 to interact with the server application 108. For example, the UI 112 may include a display 113 such as a computer monitor for viewing contact data and/or input forms, and an input device 114 such as a keyboard or a pointing device (e.g., a mouse, trackball, pen, or touch pad) for entering contact data for individuals into the input form (see FIG. 2B). For example, consider Ann Smith decides to have her financial portfolio managed by XYZ Bank. Thereafter, a representative of XYZ Bank explains to Ms. Smith that the XYZ Bank offers a service whereby her contact information (e.g., first name, last name, cell numbers, work number, home number, etc.) can be added to a shared directory maintained on a central server so and that appropriate XYZ Bank personnel can download her contact data from the shared directory to their mobile phones. If Ms. Smith decides to use the service, the bank can obtain her contact data by phone, in person, or through an electronic communication (e.g., e-mail, fax) to include in the directory. Thereafter, the administrator uses the UI 112 to enter the contact data into the electronic directory 110. Alternatively, a remote client computer 116 may be coupled to the server 102 via the communication network 106 such that Ms. Smith may directly interact with an input form provided by the server application 108 to enter her contact data into the electronic directory 110.

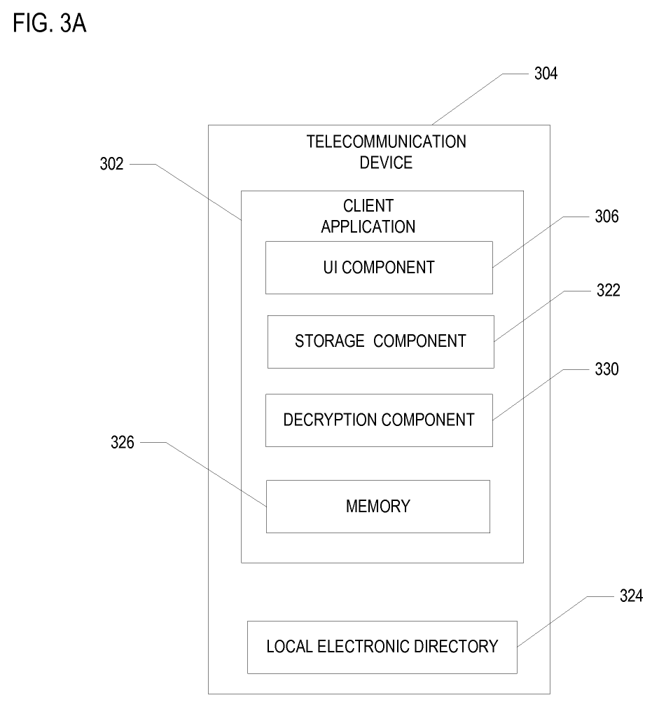

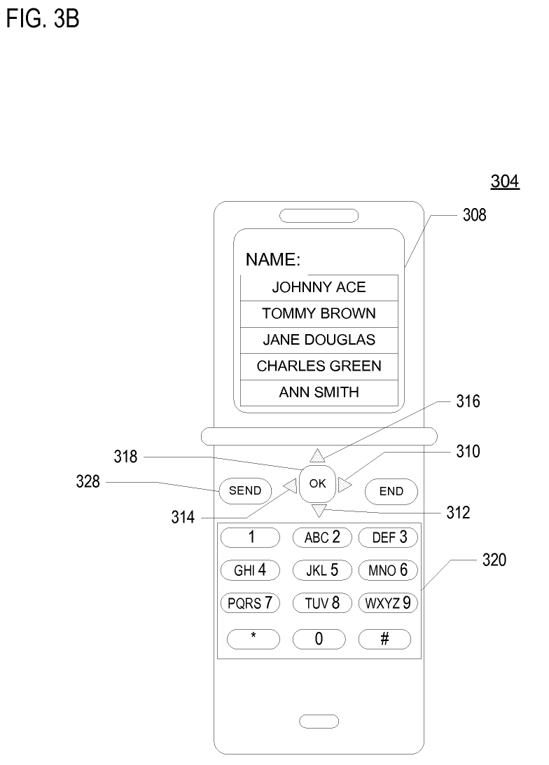

A client application 117 executed on the telecommunication device 104 is responsive to user input to generate a directory request, as indicated by arrow 118, that is provided to the server 102 via a wireless communication signal, as indicated by reference character 118. The server 102 is responsive to the received directory request 118 to retrieve contact data from the electronic directory 110 and to transfer the retrieved contact data to the telecommunication device 104. As explained in more detail below, according to one aspect of the invention, the server application 108 authenticates the received directory request 118 to determine if it is valid prior to transferring the contact data to the telecommunication device 104. After the telecommunication device 104 is authenticated, the server application 108 transfers contact data from the directory 110 to the telecommunication device 104, as indicated by arrow 122. The user of the telecommunication device 104 can then interact with a user interface on a display (e.g., See FIG. 3) of the telecommunication device 104 to view the received contact data, search the contact data for a particular individual, and/or initiate a call to a particular individual by highlighting the individuals contact data (e.g., name) and pressing a call button (e.g., “Send” or “Talk” key).

However, even if a particular individual agrees to have their contact information stored in the electronic directory 110, that particular individual may also desire to prevent particular content included in the contact data, such as their telephone number, from being viewed by users of the telecommunications device 104 even if such users are otherwise authorized to access their contact data. According to one embodiment of the present invention, the server application 108 is configured to encrypt designated contact data prior to storage in the electronic directory 110. In other words, the electronic directory 110 may include encrypted and non-encrypted contact data for a particular individual. For example, a particular individual's telephone number may be encrypted, while that individual's first and/or last name is not encrypted. Thus, the user of the telecommunication device 104 can view and interact with an individual's name via the display of the telecommunication device 104 to initiate a call, but cannot view the individual's phone number. The client application 117 is responsive to the user selecting non-encrypted name data of a particular individual and pressing, for example, the send button to decrypt the corresponding encrypted phone data to initiate a call to that particular individual. Moreover, the client application 117 will not display the decrypted phone data on the telecommunication device 104. As a result, the present invention provides an improved electronic directory 110 that allows individuals to store contact data in a shared electronic directory, and yet maintain designated contact data private.

Notably, although the invention is described herein in the context of maintaining telecommunication contact data such as a phone number private, it is contemplated that the principles of the invention can be applied to maintain other personal contact information such as an email address, instant messaging accounts or any other forms of contact information of an individual.

The exemplary operating environment illustrated in FIG. 1 includes a general purpose computing device (e.g., server 102) such as a computer executing computer-executable instructions. The computing device typically has at least some form of computer readable media (e.g., CRM 130). Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory. A user may enter commands and information into the computing device through the input device (e.g., input device 114). Other input devices (not shown) may be connected to the computing device. The computing device may operate in a networked environment using logical connections to one or more remote computers.

Although described in connection with an exemplary computing system environment, embodiments of the invention are operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Referring now to FIG. 2A, an exemplary block diagram illustrates components of a server application 202 (e.g., server application 108) being executed on a server 204 (e.g., server 102) for managing a shared electronic directory 206 storing contact data of one or more individuals. In particular, the server application 202 maintains a shared electronic directory 206 containing contact data for individuals such as business associates or clients of a business or organization. As described above, contact data can include the first name, last name, email address, phone number, mailing address, job title, and employer name for such business associates or clients. In this particular embodiment, the server application 202 maintains encrypted and non-encrypted content of contact data. For example, the shared electronic directory 206 may include non-encrypted content such as a first name, a last name, and an employer name for a particular client or business associate, and may also include corresponding encrypted content such as a telephone number or email address for that same particular client or business associate.

A UI component 208 is responsive to a data entry request received from, for example, an administrator of the server 204 using a user interface device (e.g., UI 112) to transfer a contact data entry form to the UI device 112 that allows the administrator to define contact data of a particular individual for storage in the shared electronic directory 206. As described above in reference to FIG. 1, the UI device 112 allows the administrator to interact with the contact data form to generate a storage request as indicated by reference character 209.

Referring now to FIG. 2B, there is shown an exemplary contact data form 210 used by the administrator to enter contact data of one or more individuals. Referring to the example above, using information provided by Ms. Smith, the administrator interacts with the displayed contact data form 210 to enter contact data into the appropriate contact data fields and can designate content included in contact data for encryption by selecting a corresponding encryption option button. For example, the contact data form 210 includes various data entry fields that each correspond to different content. In this example, the various entry fields include a first name field 221, a last name field 222, an employer name field 224, a mobile number field 226, a work number field 228, and a home number field 230. In the example shown in FIG. 2B, because encryption option buttons 232, 234 are not selected the name of Ann Smith's employer and her work number will be stored in non-encrypted formats. In contrast, encryption option buttons 236, 238 are selected, and, thus, Ann Smith's mobile phone number and home phone number will each be stored in an encrypted format. Notably, the contact data form 210 shown in FIG. 2B is for illustration purposes only and it is contemplated that additional and/or different contact data could be defined and/or designated for encryption. The contact data form 210 includes a duration 240 field that allows the administrator to define a contact data expiration parameter. The contact expiration parameter corresponds a specific duration of time during which a particular individual (e.g., Ann Smith) has authorized their contact data to be maintained in the electronic directory. For example, the contact data expiration parameter may set a maximum period of three (3) months, beginning from the contact data is submitted to the server for storage in the shared directory, during which the contact data can be maintained in the shared directory 206. After the administrator completes data entry for Ms. Smith, the administrator selects, for example, a save option 242 to generate the storage request 209 to add her contact data to the electronic directory 206.

Referring again to FIG. 2A, an encryption component 212 is responsive to the received storage request 209 to determine if any of the contact data has been designated for encryption. More specifically, the encryption component 212 examines the value of an encryption attribute, or flag, associated with each of the various types of contact data to determine if any of the contact data has been designated for encryption. For example, if the administrator selected an encryption option button associated with a particular type of contact data, the encryption attribute will have a value of “1” and the encryption component 212 will encrypt the corresponding contact data prior to storage in the shared electronic directory 206. Alternatively, if the administrator did not select an encryption option button associated with a particular type of contact data, the encryption attribute will have a value of “0” and the encryption component 212 will not encrypt the corresponding contact data prior to storage in the shared electronic directory 206.

In one embodiment of the invention, the encryption component 212 encrypts contact data by employing a symmetric-key encryption process. That is, the same secret key (code) used to encrypt contact data on the server 204 will be used to decrypt the contact data on the telecommunication device 104. The encryption component 212 retrieves the symmetric key from a memory 214 of the server application 202 and executes an encryption algorithm to perform a mathematical operation on the designated contact data (e.g., encryption flag=1) to convert it into encrypted contact data. More specifically, the encryption algorithm is used in conjunction with the retrieved symmetric key to encrypt the contact data. As known to those skilled in the art, a number of encryption algorithms (e.g., 3DES and HMAC-RC4) can be used to encrypt data such that it is nearly impossible to decrypt the content without knowledge of the encryption key. Notably, it is contemplated that other encryption techniques, such as a public/private key pair method, could be used to implement aspects of the invention. A storage component 216 is responsive to the storage request 209 and the output from the encryption component 212 to store non-encrypted contact data and encrypted contact data in the shared electronic directory 206.

Referring now to FIG. 3A, an exemplary block diagram illustrates components of a client application 302 (e.g., client application 117) being executed on a telecommunication device 304 (telecommunication device 104) for communicating with a server (e.g., server 204) to retrieve contact data of one or more individuals. In particular, the client application 302 communicates with a server via a wireless communication network to obtain encrypted and non-encrypted contact data from a shared electronic directory (e.g., shared electronic directory 110) maintained on the server.

A UI component 306 is responsive to input received from a user of the telecommunication device 304 (e.g., telecommunication device 104) to generate a directory request (e.g., directory request 118) to retrieve contact data of a particular individual from a shared electronic directory. For example, the user of a telecommunication device 304 interacts with a graphical display displayed on a display of the telecommunication device 304 to select, a menu option that allows the user to retrieve contact data contained in a particular shared electronic directory located on a particular server. Referring briefly to FIG. 3B, there is shown an exemplary telecommunication device 304 capable of executing the client application 302 to retrieve contact data from a shared electronic directory on a server. The client application 302 displays various graphical user interfaces on a display 308 of the telecommunication device 304 in response to user input. For example, the client application 302 is responsive to user input to display, for example, an address book menu (not shown) on the display 308 that allows the user to view contact data stored in a local electronic directory, add or make edits to contact data in the local electronic directory, and/or download contact data from a shared electronic directory (e.g., shared electronic directory 206). The user uses direction keys 310, 312, 314, 316 and OK key 318 to select, for example, a download option from the phone menu to generate a directory request 208 to retrieve contact data from the shared electronic directory (e.g., shared electronic directory 206). The directory request 208 may also include authentication data used by the server 204 to authenticate the directory request 208. For example, after the user selects the download option, a login form (not shown) is displayed on the display 308 of the telecommunication device 304 and the user use the key pad 320 to enter identification and/or password data. Alternatively, the authentication data received along with the directory request 118 may correspond to a device ID associated with the particular telecommunication device 304 providing the directory request 118. For example, the telecommunication device 304 can have a unique device ID stored in a memory of the device 304. When a particular phone is first authorized to retrieve contact data from the shared directory of a particular server, an initial communication session is conducted between the server and the telecommunication device 304. During this initial communication session, the telecommunication device 304 provides the unique device ID to the server for storage.

Referring again to FIG. 2A, an authentication component 218 authenticates the directory request 118 to verify that the user of the telecommunication device 304 is authorized to access the shared electronic directory 206. The authentication component 218 authenticates the directory request 208 by comparing authentication data received from the telecommunication device 304 along with the directory request 118 to authorization data stored in a database 211 on the server 204. For example, the database 211 is a validation database that contains information necessary to validate a request from a client 116 (as well as other users on the network) to retrieve contact data from the shared directory 206. Although database 211 is shown contained within server 204, it is to be understood that in other embodiments of the invention, database 211 may be located on a separate authentication server (not shown) coupled to the server 204. Stored authentication data may include a password previously defined by the user of the telecommunication device 304 or a device ID previously provided from the telecommunication device 304. If authentication data received from the telecommunication device 304 does not match the authentication data stored in the database 211 the user is not authenticated and the user is denied access to the stored electronic directory. On the other hand, if the authentication data received from the telecommunication device 304 matches the authentication data stored in the database 211, the user is authenticated, and allowed to retrieve contact data from the shared directory 206.

A transfer component 220 is responsive to an authenticated directory request to transfer contact data to the telecommunication device 304. The transfer component 220 also retrieves the symmetric key used to encrypt designated contact data and a key expiration parameter from memory 214, and transfers the retrieved key and key expiration parameter to the telecommunication device 304. The key expiration parameter defines a maximum duration of time that the retrieved symmetric key can be used by the client application 302 of the telecommunication device 304 to decrypt encrypted contact data. For example, the key expiration parameter may set a maximum period of six (6) hours, beginning from the time encrypted content is transferred from the server 204 to the telecommunication device 304, during which the key can be used by the telecommunication device 304 to decrypt encrypted contact data.

In one embodiment, the transfer component 220 retrieves the contact expiration parameter from memory 214 prior to transferring encrypted and non-encrypted content to the telecommunication device 304. If the period of time authorized by a particular user for maintaining their contact data in the directory has expired, the transfer component 220 will not transfer any contact data of that particular individual to the telecommunication device 304.

Referring again to FIG. 3A, a storage component 322 of the client application 302 is responsive to contact data transferred from the shared directory 206 of the server 204 to store the received contact data in a local directory 324. The storage component 322 also stores the key along with an expiration parameter in a memory 326 of the telecommunication device 304. Thereafter, after the UI component 306 is responsive to user input to display non-encrypted contact data stored in the local directory 324 on the display 308 of the telecommunication device 304. For example, non-encrypted contact data such as the first and last names of individuals can be displayed on the display 308 of the telecommunication device 304.

In operation, a user of the telecommunication device 304 uses, for example, the direction keys 312 and 316 on the telecommunication device 304 to select the name of a particular individual displayed on the display 308. The user presses a send key 328 (See FIG. 3B) to initiate a call to that particular individual. A decryption component 330 is responsive to user input (i.e., pressing the send key 328) to retrieve the decryption key from the memory 326 of the telecommunication device 304 and executes a decryption algorithm to perform a mathematical operation on the corresponding encrypted contact data, such as the particular individual's telephone number, to initiate the call using a convention telecommunication protocol. According to one aspect of the invention, the UI component 306 prevents decrypted contact data from being displayed on the display 308 of the of the telecommunication device 304. That is, even after the decryption component 324 has decrypted contact data, the UI component 306 will not allow any decrypted contact data to be displayed on the display 308 of the telecommunication device 304.

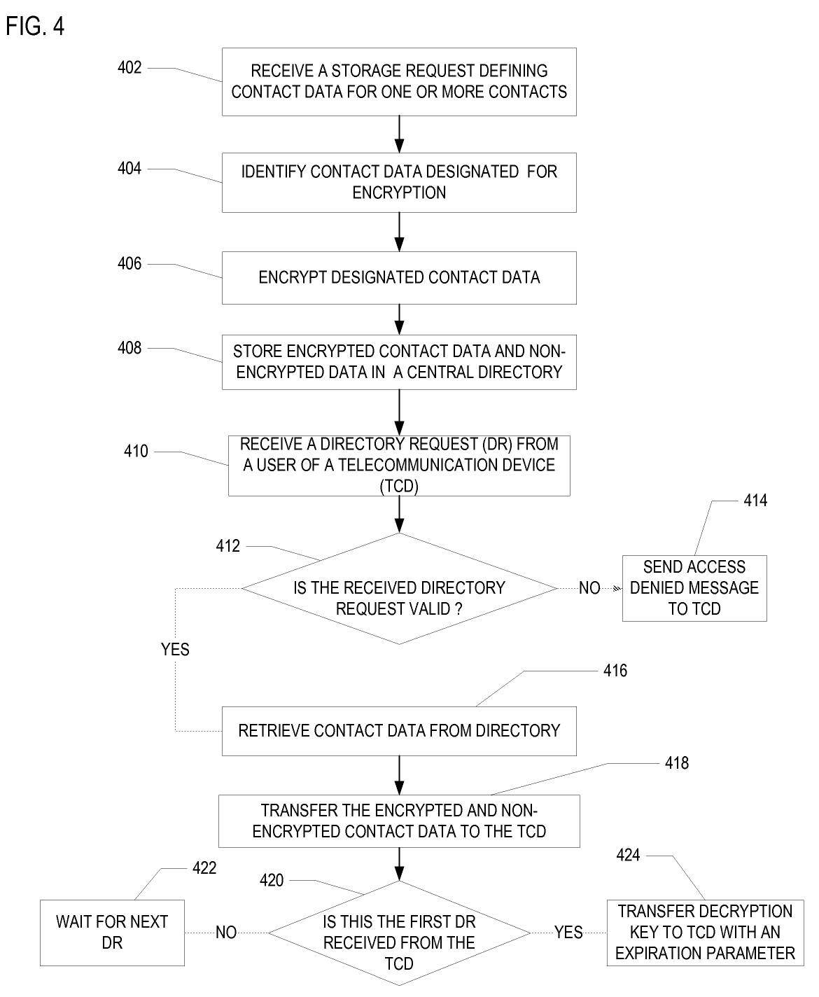

Referring now to FIG. 4, an exemplary flow chart illustrates a method for storing contact data of one or more individuals in shared directory according to one exemplary embodiment of the invention. A storage request is received by a server on which the shared directory is located from an administrator of the server at 402. As described above, the storage request includes contact data of a particular individual the administrator would like to add to the shared electronic directory 206. At 404, a server application executing on the server is responsive to the storage request to determine a value of an encryption attribute associated with content included in the received contact data received at 402 to identify content designated for encryption. The server application encrypts the designated content of the contact data as a function of a symmetric key retrieved from memory at 406. The server application stores encrypted content and non-encrypted content in the shared directory at 408. In other words, content designated for encryption is stored in the shared directory in an encrypted format, and, content that is not designated for encryption is stored in the directory in a non-encrypted format.

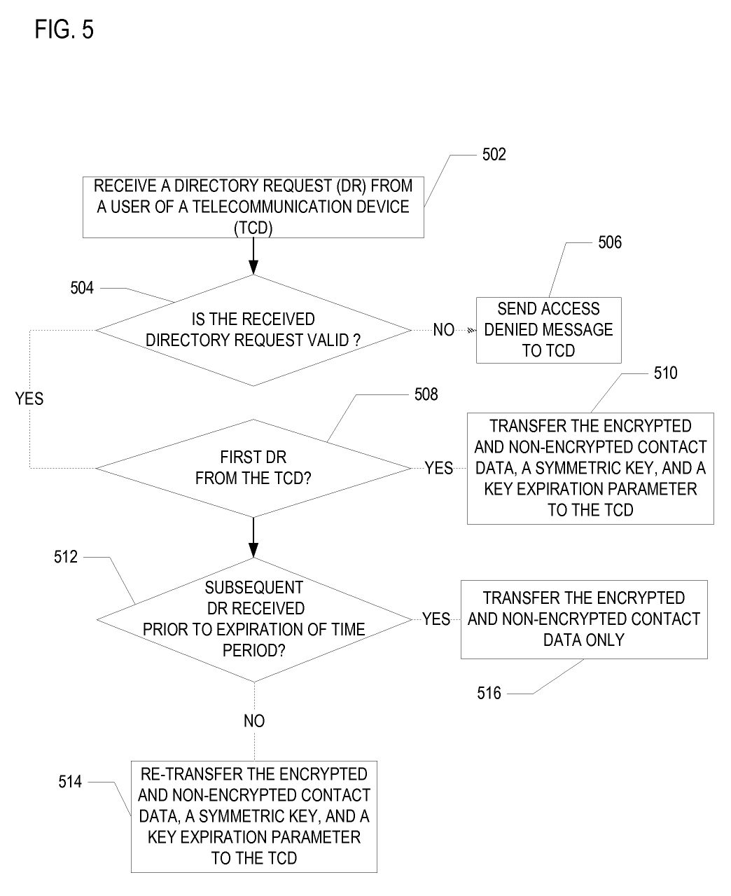

Referring now to FIG. 5, an exemplary flow chart illustrates a method for transferring contact data of one or more individuals from a server to a telecommunication device according to one exemplary embodiment of the invention. A directory request is received at the server from the user of a telecommunication device at 502. At 504, the server application determines if the received directory request is valid. For example the server application compares authentication data (e.g., password) received along with the directory request to authorization data stored in a database on the server to determine if the directory request is valid. If the directory request is determined invalid at 504 (e.g., received authentication data does not match stored authentication data), the user of the telecommunication device is denied access to the shared directory at 506. Alternatively, if the directory request is determined valid at 504 (e.g., received authentication data matches the stored authentication data), the server application determines if the received directory request is the first directory request received from the telecommunication device at 508. For example, the first time the server application transfers contact data to the telecommunication device, a unique cookie is transferred and stored on the telecommunication device. Thus, the server application can determine if the received directory request is the first directory request by determining if a cookie was previously stored on the telecommunication device. If the server application determines that the received directory request is the first directory request received from the telecommunication device at 508, the server application transfers contact data, the symmetric key, and a key expiration parameter to the telecommunication device at 510. As described above, the expiration parameter defines a period of time during which the symmetric key can be used on the telecommunication device to decrypt encrypted contact data. In addition to transferring a unique cookie to the telecommunication device in response to a directory request, the server application transfers time stamp data along with the cookie. Accordingly, the server application can determine how long after the initial transfer of contact data, a subsequent directory request is received by comparing the previously transferred time stamp data with current time data. If the server application determines that the received directory is not the first directory request received from the telecommunication device at 508, the server application determines if the subsequent directory request is received prior the expiration of the time period defined by the key expiration parameter at 512. If the server application determines the subsequent directory request is retrieved after the expiration of the time period defined by the key expiration parameter at 512, the server application will re-transfer contact data, the symmetric key, and a new key expiration parameter at 514. Notably, although the key expiration parameter may define the same amount of time (e.g., 6 hours), time period during which the symmetric key can be used will begin from the time the contact data is re-transferred to the telecommunication device and end, for example, six hours from the re-transfer time. If the server application determines the subsequent directory request is retrieved prior to the expiration of the time period defined by the key expiration parameter at 512, the server application will only re-transfer encrypted and non-encrypted contact data at 516. As a result, even authorized users of telecommunication devices will have to periodically re-authenticate themselves to the server application to retrieve a new key expiration parameter so that the symmetric key can be used to decrypt encrypted contact data.

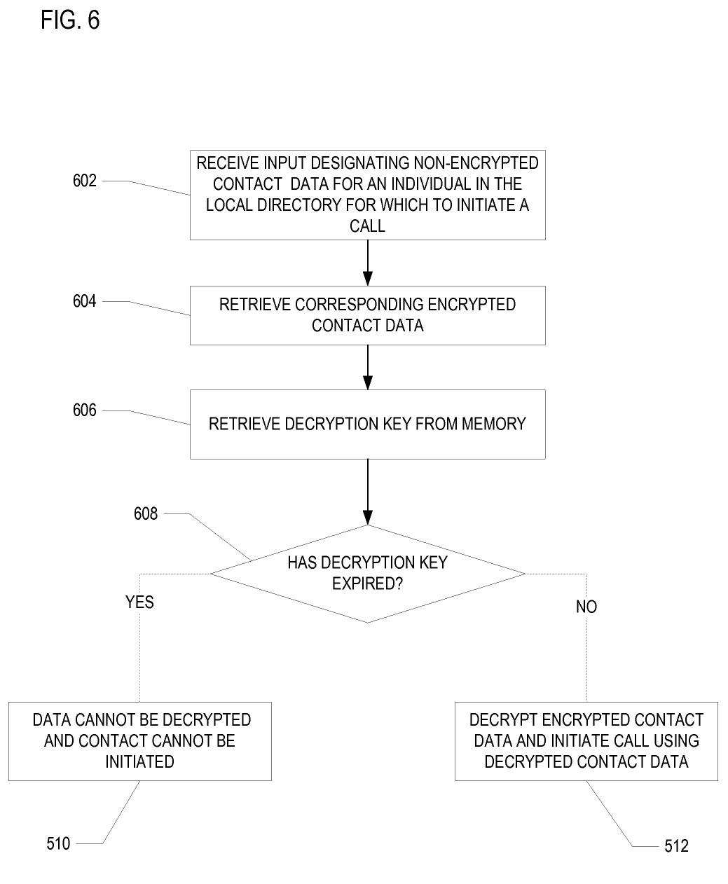

Referring now to FIG. 6, an exemplary flow chart illustrates a method for initiating contact via a telecommunication device using encrypted contact data received from a server according to one exemplary embodiment of the invention. A client application receives user input designating non-encrypted contact data of a particular individual for which to initiate contact at 602. For example, the user selects and enters non-encrypted contact data such as the first name of a particular individual displayed on a display of the telecommunication device. At 604, the client application is responsive to the received user input to retrieve corresponding encrypted contact data such as the particular individuals encrypted phone number. The client application retrieves a decryption key and an expiration parameter associated with the decryption key from memory at 606. At 608, the client application determines if the decryption key has expired based on the associated expiration parameter. For example, as described above, the expiration parameter defines a maximum time period that the telecommunication device can be used by the client application of the telecommunication to decrypt encrypted contact data. If the client application determines the decryption key has expired at 608, the client application cannot decrypt the encrypted contact data and, thus, is prevented from initiating contact with the particular individual at 610. If the client application determines the decryption key has not expired at 608, the client application decrypts the encrypted contact data and initiates contact with the particular individual at 612.

In operation, server 102 and telecommunication device 104 executes computer-executable instructions such as those illustrated in the figures to implement embodiments of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of embodiments of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. As various changes could be made in the above constructions, products, and methods without departing from the scope of aspects of the invention, it is intended that all matter contained in the above description and shown in the accompanying drawings shall be interpreted as illustrative and not in a limiting sense.

1-20. (canceled)

21. A computer implemented method for storing contact data in an electronic directory, said electronic directory being located on a server and including contact data of a plurality of individuals, said method comprising:
receiving, at the server, a storage request from a user of the server, said storage request including contact data of a particular individual to be stored in the electronic directory and including an associated encryption attribute;
identifying a content of the contact data to encrypt as a function of the associated encryption attribute;
encrypting the identified content of the contact data; and
storing the encrypted content in the electronic directory.

22. The method of claim 21, wherein the identifying includes identifying a different content of the contact data that should be non-encrypted as a function of its associated encryption attribute, and wherein the storing includes storing both encrypted content and the non-encrypted different content in the electronic directory.

23. The method of claim 21, wherein the content of the contact data includes one or more of the following:
a first name;
a last name;
a job title;
an employer name;
a work phone number; and
a mobile phone number.

24. The method of claim 21, wherein the encryption attribute has a first default value indicating that the associated content should be non-encrypted, and wherein the encryption attribute has a second value set by the user indicating that the associated content should be encrypted.

25. The method of claim 21 further including transferring contact data from the server to a telecommunication device via a communication network, wherein the encrypting includes encrypting the identified content using a shared symmetric key, said shared key being transferred from the server to the telecommunication device to allow for the decryption of any encrypted content included in the transferred contact data.

26. The method of claim 25, wherein the shared symmetric key is retrieved from a memory of the server, or wherein the shared key comprises a randomly generated, single-use session key.

27. The method of claim 26 further including associating a key expiration parameter with the shared symmetric key, said key expiration parameter defining a period of time during which the shared symmetric key can be used by the remote telecommunication device to decrypt encrypted content types.

28. The method of claim 21, wherein the storage request further includes a contact data expiration parameter, said contact data expiration parameter indicating a specific duration of time during which the contact data of the particular individual has been authorized for storage in the electronic directory.

29. A computer implemented method for transferring contact data from a server to a telecommunication device, said method comprising:
receiving, at the server, a directory request from a user of the telecommunication device, said directory request including identification data for the user of the telecommunication device;
determining whether the directory request is valid based on the identification data;
retrieving contact data from an electronic directory stored on the server in response to a valid directory request, said electronic directory storing contact data of a plurality of individuals, and said retrieved contact data including encrypted content and non-encrypted content; and
transferring the encrypted content and non-encrypted content to the telecommunication device.

30. The method of claim 29, wherein the retrieving further includes retrieving a shared symmetric key from a memory of the server for decrypting the encrypted content, and wherein transferring includes transferring the encrypted content, the non-encrypted content, and the retrieved shared key to telecommunication device.

31. The method of claim 30 further including retrieving a key expiration parameter from a database, said key expiration parameter defining a period of time during which the shared symmetric key can be used by the telecommunication device to decrypt encrypted content transferred from the server.

32. The method of claim 30, wherein the identification data includes validation data supplied by the user of the telecommunication device, and wherein determining whether the directory request is valid includes comparing the supplied validation data to a predefined validation data stored in the memory of the server.

33. The method of claim 30, wherein the identification data included in the directory request includes device identification data received from the telecommunication device, and wherein determining whether the directory request is valid includes comparing the received device identification data to an approved device identification data stored in the memory of the server.

34. The method of claim 29 further including retrieving an associated contact data expiration parameter for each of the plurality of individuals, said associated contact data expiration parameter defining a specific duration of time that the contact data of a particular individual has been authorized for storage in the electronic directory, and wherein the retrieving includes retrieving contact data of one or more of the plurality of individuals when their associated contact data expiration parameter defines a specific duration of time duration that has not expired.

35. A system for transferring contact data from a server to a telecommunication device in response to a directory request received from a user of the telecommunication device, said directory request including identification data for the telecommunication device, said system comprising:
an authentication component for determining whether the directory request is valid based on the identification data;
a transfer component for retrieving contact data from an electronic directory stored on the server in response to a determined valid directory request, said electronic directory storing contact data of a plurality of individuals, and wherein said transfer component transfers the retrieved contact data to the telecommunication device.

36. The system of claim 35, wherein the contact data retrieved from the electronic directory includes encrypted content and non-encrypted content, and wherein the transfer component further retrieves a shared symmetric key from a memory of the server, and wherein the transfer component transfers encrypted content, non-encrypted content, and the retrieved shared key to the telecommunication device.

37. The system of claim 36, wherein the transfer component further transfer a key expiration parameter from the memory of the server, said key expiration parameter defining a period of time during which the shared symmetric key can be used by the telecommunication device to decrypt encrypted content transferred from the server.

38. The system of claim 36, wherein the identification data includes:
validation data supplied by the user of the telecommunication device, and wherein the authentication component determines whether the directory request is valid by comparing the user supplied validation data to predefined validation data stored in a database on the server; or
device identification data received from the telecommunication device, and wherein determining whether the directory request is valid includes comparing the received device identification data to approved device identification data stored in the database.

39. The system of claim 38, wherein the transfer component further retrieves a contact data expiration parameter for each of the plurality of individuals from the database, said contact data expiration parameter defining a duration of time the contact data of a particular individual has been authorized for storage in the electronic directory, and wherein the transfer component only transfers contact data of one or more of the plurality of individuals having expiration parameter defining a period of time that has not expired.
